(19) United States
(12) Patent Application Publication
(10) Pub. No.: US 2008/0313707 A1
(43) Pub. Date: Dec. 18, 2008

(54) Token-based system and method for secure authentication to a service provider

(75) Inventors: Manoj Jain, Austin, TX (US); Shradha Dube, Austin, TX (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: TECHPORCH, INC.

(21) Appl. No.: 12/214,100

(22) Filed: Jun. 17, 2008

Related U.S. Application Data
(60) Provisional application No. 60/936,088, filed on Jun. 18, 2007.

(51) Int. Cl. H04L 9/32; H04L 9/00

(52) U.S. Cl. 726/2; 380/255

(57) ABSTRACT

A method is provided for authenticating the current user of a device to a service provider. The method comprises (a) capturing an initial set of credentials from the owner of the device; (b) storing the initial set of credentials in a memory provided in the device; (c) storing the owner's secrets corresponding to a plurality of service providers in the memory provided in the device; (d) receiving an authentication request from one of said plurality of service providers; (e) in response to the authentication request, capturing a set of credentials from the current user of the device; and (f) revealing the owner's secrets which correspond to the service provider requesting the authentication if and only if the current user's credentials match the owner's credentials.

### CROSS-REFERENCE TO RELATED APPLICATIONS

This application claims the benefit of the priority date of U.S. Provisional Application No. 60/936,088, filed Jun. 18, 2007, having the same inventors, and which is incorporated herein by reference in its entirety.

### FIELD OF THE DISCLOSURE

The present invention relates generally to transactional security, and more specifically to methods for authenticating a user to a service provider.

### BACKGROUND OF THE DISCLOSURE

The need frequently exists for a user to authenticate himself to a service provider. For example, an on-line banking system must typically verify the identity of a user before the user can be permitted to perform transactions on the system, or before account statements or other confidential information may be released to that person. Similarly, an electronic security system must typically verify the identity of a user before the user can be allowed access to a restricted area. Various methods for authenticating a user to a service provider for these and other purposes are currently known to the art.

FIG. 1 depicts a system of this type which is currently known in the art. The system 101 depicted therein comprises a service provider 103 which is in communication with a local system 105 via a network 107 such as the Internet. The service provider 103 has associated therewith a database 109 to which a user on the local system 105 is seeking access. The database may contain, for example, information about the user's account with the service provider. Before the user is granted access to the database 109, a login page 111 on the service provider's website authenticates the user by requesting the input of a previously established username 113 and password 115.

FIG. 2 shows a system 201 which is similar in some respects to the system 101 of FIG. 1. However, in this system 201, the user is authenticated through possession of a proximity badge 213 rather than through the provision of a user ID and password. Systems of the type depicted in FIG. 2 are frequently used to control access to restricted areas.

The systems of FIGS. 1-2 have some notable advantages. In particular, these systems are simple to implement and use, and require minimal hardware. Moreover, in the case of the system of FIG. 1, the user can typically access his account from any computer, including computers at libraries, coffee houses or other public places.

However, these systems also have some notable disadvantages. For example, the system of FIG. 1 is typically only as secure as the password chosen by the user. If the user picks a password that is easy to guess, the security of the system is easily compromised. Moreover, most users tend to use the same set of passwords over and over for different service providers. Hence, if the database of one service provider is compromised, the user's accounts with many different service providers may be at risk. In addition, unless the on-line site associated with the service provider uses special methods such as site-sealing, user authentication on the site is prone to phishing scams. In such scams, a false on-line site may gather the user's credentials by pretending to be an on-line service provider.

The system of FIG. 2 suffers from the drawback that authentication is tied to possession of the proximity badge. Hence, an unauthorized party who gains possession of the badge can gain access to the secured area.

FIG. 3 illustrates another system known to the art. In this system 301, the user authenticates to the service provider 303 using more than one authentication factor. In particular, the system requires a user seeking to gain access to the system 301 from a local system 305 to input a username 313 and password 315, along with the answer to a secret question 317. The secret question and its answer will typically have been determined during a previous enrollment process.

The system 301 of FIG. 3 is advantageous in that it provides a simple form of multi-factor authentication, thereby making it harder to access the user's account even if the user's password 315 can be easily guessed. Moreover, as with the systems depicted in FIGS. 1-2, the system 301 of FIG. 3 requires minimal hardware, and as with the system of FIG. 1, the user may access his/her account from any computer.

Unfortunately, most of the problems inherent in the system of FIG. 1 also remain with this approach. In particular, if the user continues to use the same secret question for most of his on-line accounts, this method can readily fail. Similarly, in the absence of site-sealing or other such methods, this approach to authentication is prone to phishing scams.

FIG. 4 depicts a further approach known to the art. In the system 401 depicted therein, which is a variation of the foregoing systems, third party password management software 417 is installed on the local system 405, which may be, for example, a client computer (i.e., the local computer used to log onto the system). The password management software 417 maintains a database 419 of username and passwords for various applications and service providers. When the user attempts to access an application or an on-line account, the password management software may require the user to authenticate himself with biometrics or smart cards before automatically filling in the user's credentials from its local database.

The system 401 depicted in FIG. 4 has some notable advantages. In particular, the local database 419 of the password management software 417 may be protected with multi-factor authentication. Moreover, the actual password (and secret question) for the on-line account may be quite complex and may also be different for different on-line sites, since the user no longer has to remember this information and the information is automatically filled in by the password management software 417 after it authenticates the user. In addition, this approach is more resistant to phishing attacks, since the password management software 417 will not release the user's credentials unless the URL of the site (or the title of the application) matches the URL or title saved in the database 419.

Unfortunately, the system depicted in FIG. 4 also has some infirmities. In particular, in this type of system, the user may no longer be able to access his/her accounts from any computer. In particular, the method for authenticating the user from the database 419 can only work from a computer on which the password management software 417 and its associated database 419 are installed or accessible. Moreover, the user may not be able to access his/her on-line accounts from another computer not in communication with the database 419, because the passwords may be too complex, and the user may not remember them. Furthermore, unless the service provider is using secure protocols to protect the data in transit, this data can be intercepted by malicious software or entities, whether or not the database 419 is utilized. Therefore, replay attacks on systems of this type are still possible. In addition, if the user is accessing an account from a computer which also has key-logging software installed, the key-logging software can record the user's credentials as they are being automatically filled by the password management software 417.

FIG. 5 illustrates still another approach known to the art. In the system 501 depicted therein, a local system 505 is in communication with service providers 503 and 504 over a network 507. A user on the local system 505 who wishes to gain access to databases 509 and 510 associated with respective service providers 503 and 504 is issued respective RSA IDs 519 and 520, typically during an enrollment process. RSA IDs 519 and 520 display some information that changes continuously. When the user is attempting to gain access to databases 509 and 510 associated with respective service providers 503 and 504, the user must read the information currently being displayed on the issued device and provide that information to the service provider, along with the usual credentials (e.g., username and password).

The system depicted in FIG. 5 has some notable advantages. In particular, this system provides better security than some of the previously noted systems, since the system of FIG. 5 combines two forms of authentication (“what you have” authentication along with “what you know” authentication) with the use of simple hardware. Moreover, while phishing sites may be able to obtain the user's password and username, and possibly even the information displayed by the token, more than likely, that information will be useless because the token's information would have changed by the time access to the user's account is attempted later by a malicious entity.

However, the system depicted in FIG. 5 also has some drawbacks. In particular, the user may have to carry a different token for every service provider that is protected by this method. Moreover, this method does not entirely remove the risk of phishing, since the window of opportunity has been made smaller, but has not been eliminated. In particular, if a phishing site can relay the user-provided data to the service provider in real time (or close enough), the phishing site may still be able to obtain access to the user's account with the service provider.

FIG. 6 illustrates still another approach known to the art. This system 601, which is described in U.S. Patent Application No. 2007/0022196 (Agrawal), is similar to the previously described system, except that a single token 619 is utilized to gain access to databases 609 and 610 which are associated with multiple respective service providers 603 and 604. The token 619 requires one or more additional servers 621 which are used to complete the authentication of the user with the token 619 before access is granted to the desired on-line service provider 603 or 604.

The approach depicted in FIG. 6 has a number of advantages. In particular, and in contrast to the previously described approach, the user now has to carry just one token 619 that can be used to gain access to multiple on-line accounts 603 or 604.

However, this approach is also beset with certain drawbacks. In particular, authentication is performed remotely by an additional common server 621 that needs to be set up. Information entered by the user is first sent to this server 621 which performs the initial authentication. After the user has been successfully authenticated with this server 621, the information is passed along to the actual on-line service provider 603 or 604. The on-line service provider then does the final authentication using the credentials provided before granting access to the respective database 609 or 610 associated with the service provider. Hence, the need for the extra server 621 raises additional bandwidth, delay and downtime issues. Moreover, the availability of this authentication methodology depends on the availability of the additional server 621. Furthermore, such a token 619 cannot be used to authenticate to applications or service providers where no Internet connection is available (e.g., in situations involving access control systems for doors), or in applications on systems that have disabled Internet access due to security considerations. In addition, this method does not remove the risk of phishing entirely, since it has made the window of opportunity smaller but has not eliminated it entirely. Hence, if a phishing site can relay the user-provided data to the common server in real time (or close enough), it is possible that the phishing site will still be granted access to the user's account.

### SUMMARY OF THE DISCLOSURE

In one aspect, a method is provided for authenticating the user of a device as the owner of the device. The method comprises (a) capturing an initial set of credentials from the owner of the device; (b) storing the initial set of credentials in a memory provided in the device; (c) storing the owner's secrets corresponding to a plurality of service providers in the memory; (d) receiving an authentication request from one of said plurality of service providers; (e) in response to the authentication request, capturing a set of credentials from the current user of the device; and (f) revealing the owner's secrets which correspond to the service provider requesting the authentication if and only if the current user's credentials match the owner's credentials.

In another aspect, a device is provided which comprises (a) a memory adapted to store the credentials of the device's owner therein, and being further adapted to store the owner's secrets for a plurality of service providers therein; (b) an owner authentication engine which is adapted to capture and record credentials from the owner of the device, and which is further adapted to compare those credentials with the credentials of the current user of the device; (c) a method adapted to allow the device to communicate with the plurality of service providers; and (d) a request processing engine on the device, said request processing engine being adapted, upon a request from one of said service providers, to authenticate the owner, and being further adapted, upon successful authentication of the owner, to reveal the owner's secrets which correspond to that service provider.

In a further aspect, a system is provided which comprises (a) a plurality of service providers; (b) a user registered with said plurality of service providers; and (c) a device adapted to allow the user to obtain access to services from any of said service providers by releasing to that service provider a secret which is specific to that service provider and which is stored on the device; wherein the device is further adapted to obtain a first set of credentials from the user of the device and to compare the first set of credentials with a second set of credentials which are stored on the device and which were obtained from the owner of the device.

In still another aspect, a method for authenticating a first party to a second party, comprising: (a) requiring the first party to demonstrate knowledge of a secret shared between the first and second parties; (b) requiring the first party to establish possession of a token; and (c) requiring the first party to demonstrate ownership of said token.

### BRIEF DESCRIPTION OF THE DRAWINGS

FIG. 1 is an illustration of a prior art system for authenticating a user.

FIG. 2 is an illustration of a prior art system for authenticating a user.

FIG. 3 is an illustration of a prior art system for authenticating a user.

FIG. 4 is an illustration of a prior art system for authenticating a user.

FIG. 5 is an illustration of a prior art system for authenticating a user.

FIG. 6 is an illustration of a prior art system for authenticating a user.

FIG. 7 is an illustration of a particular, non-limiting embodiment of a system for authenticating a user in accordance with the teachings herein.

FIGS. 8-9 are flowcharts illustrating a particular, non-limiting embodiment of the methodologies disclosed herein.

FIG. 10 is a flowchart illustrating a particular, non-limiting embodiment of the methodologies disclosed herein.

FIG. 11 is a flowchart illustrating a particular, non-limiting embodiment of the methodologies disclosed herein.

FIG. 12 is a flowchart illustrating a particular, non-limiting embodiment of the methodologies disclosed herein.

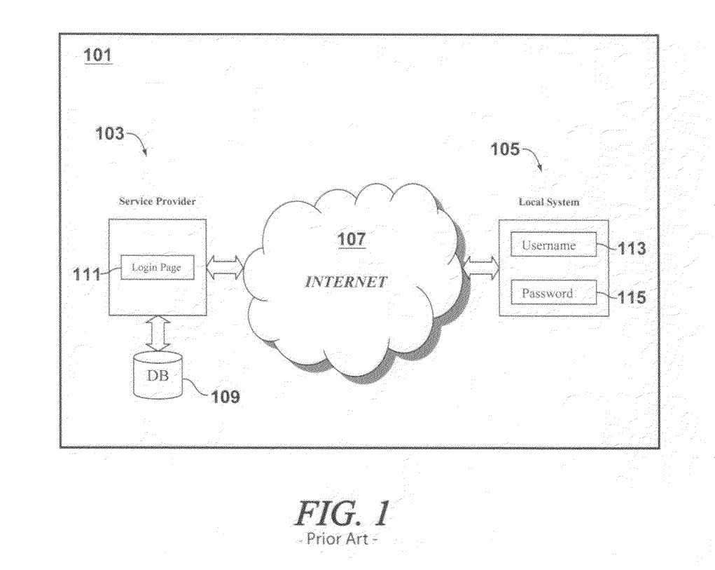

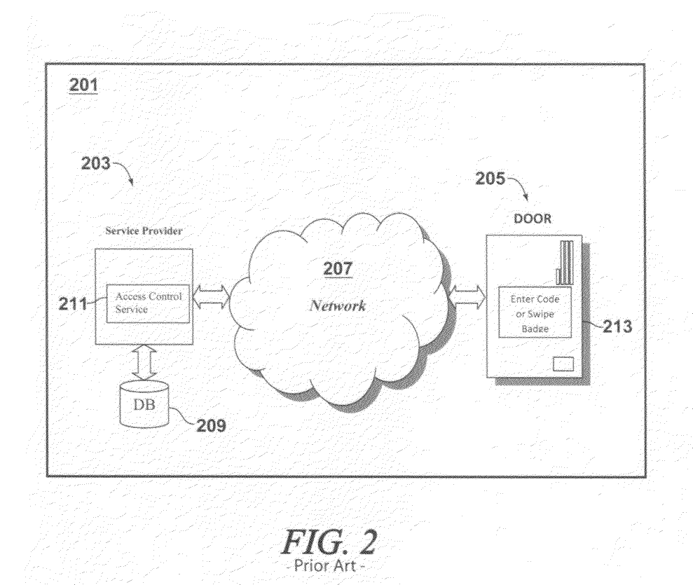

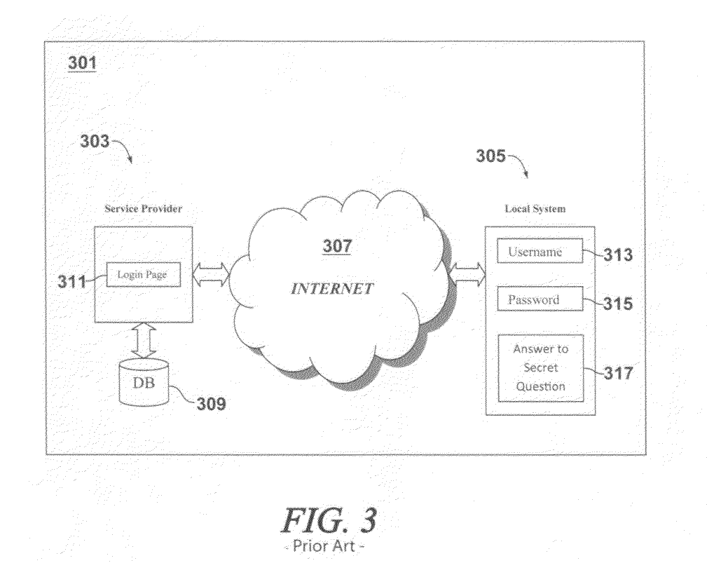

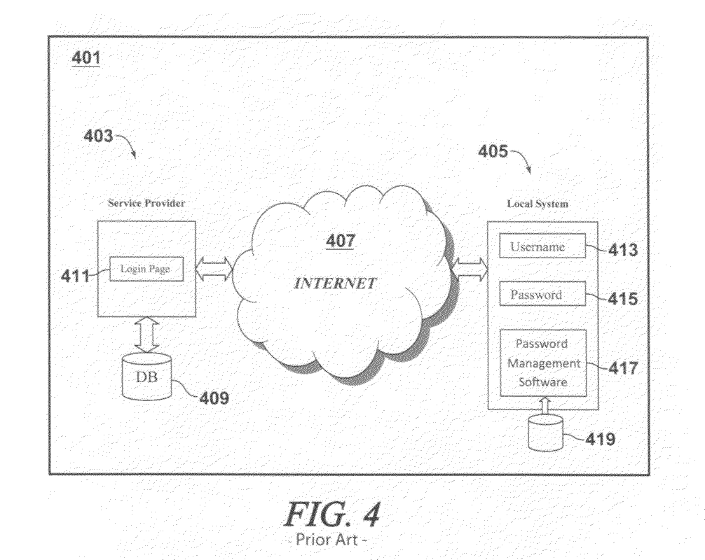

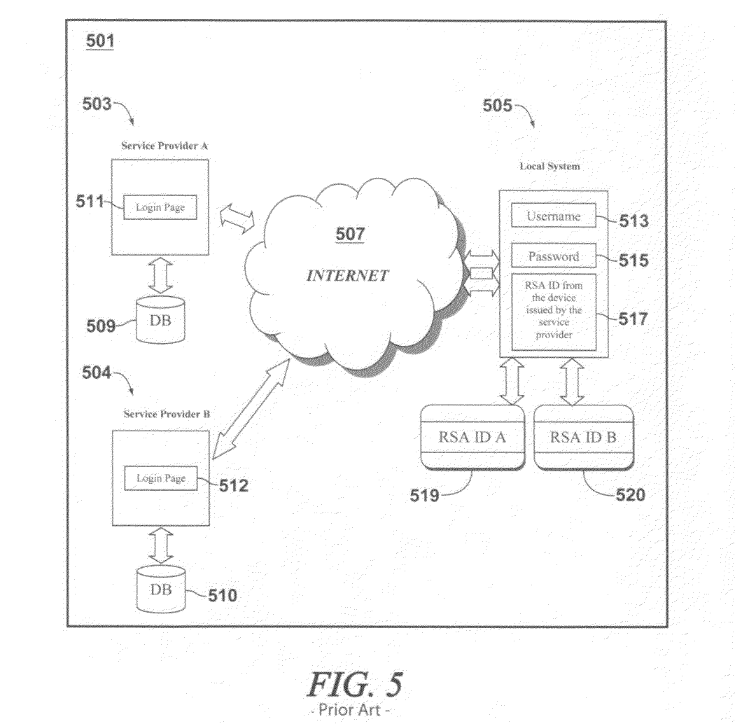

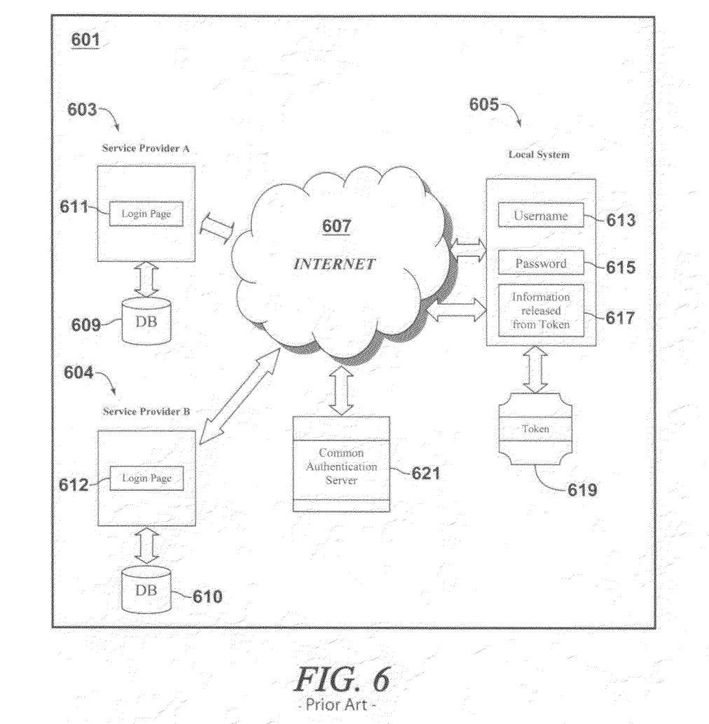

### DETAILED DESCRIPTION

It has now been found that the infirmities in the above noted existing systems may be overcome through the provision of systems and methodologies of authenticating a user to a service provider wherein the authentication is based on (a) possession of a token by the user, (b) a means for establishing the user of a token as the original owner of the token, (c) a means built into the token for authenticating the user as the original owner of the token, (d) a means for saving a secret on the token (wherein the secret is specific to the service provider) after authenticating that the token is in the hands of its original owner, and (e) a means for releasing the secret from the token upon receiving an authentication request from a service provider, wherein the secret is released after the user is authenticated as the original owner of the token.

In a preferred embodiment, the foregoing objective is accomplished through the use of a token which is adapted to store the secrets of a plurality of service providers therein, and which is also adapted to ascertain biometric features of the user (as through the use of a built-in biometric scanner) and to compare those features with biometric features of the owner of the token which are stored in the memory of the device. Upon receiving an authentication request from a service provider (as when the user attempts to use the token to gain access to an account that the owner of the token has with the service provider), the token first authenticates the user as the owner and then, upon successful authentication, releases the appropriate secrets to the service provider.

In another embodiment, the foregoing objective is accomplished through the use of a Smart Card with a built-in application which is adapted to store the secrets of a plurality of service providers therein only after the owner has unlocked the Smart Card with a PIN/passphrase. Upon receiving an authentication request from a service provider (as when the user attempts to use the Smart Card to gain access to an account that the owner of the token has with the service provider), the Smart Card application first requires the current user to provide the owner's PIN/passphrase and only upon successful authentication, releases the owner's secrets corresponding to the service provider who initiated the authentication request.

The token will typically be equipped with encryption/decryption capabilities and will also preferably be adapted to participate in a key exchange procedure with the service provider. This arrangement allows the authentication request from the service provider to be encrypted such that it can only be decrypted by the token. This arrangement also allows the response to the authentication request to be decrypted only by the service provider which initiated the authentication request, and to which the secrets correspond.

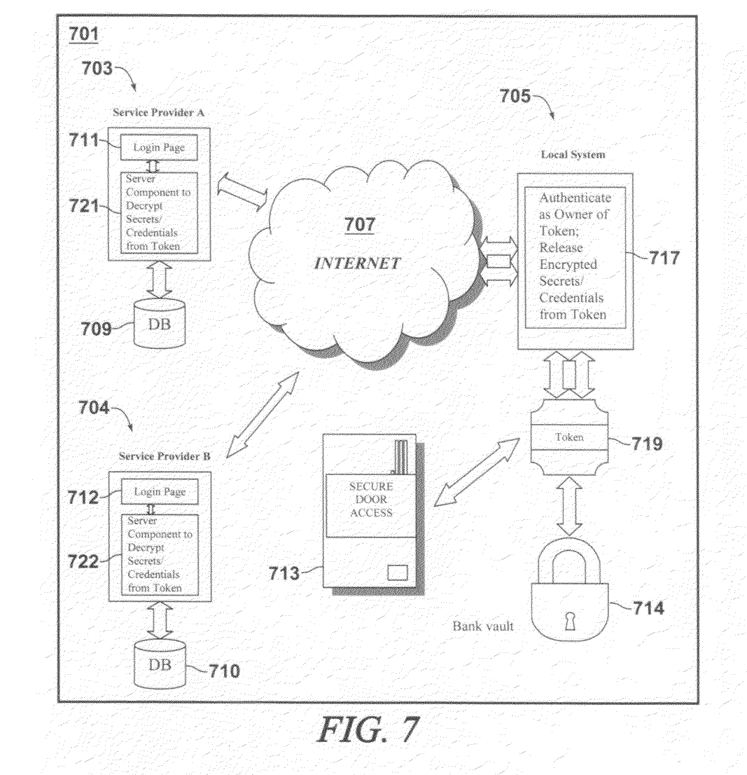

FIG. 7 illustrates a first particular, non-limiting embodiment of a system in accordance with the teachings herein. In the system 701 depicted therein, a local system 705 is in communication with service providers 703 and 704 over a network 707. The network is typically the Internet, but may also be various other types of networks, including local networks and WANs. A user on the local system 705 who wishes to gain access to information contained on databases 709 and 710, which are associated with respective service providers 703 and 704, is issued a token 719. The token may be issued during an enrollment process with one of the service providers, or may be obtained separately by the party using the token. The service providers may be any type of online service provider. For example, service providers 703 and 704 may be financial institutions, brokers, online retailers, or other institutions where the user has accounts.

Service providers 703 and 704 preferably have login pages 711 and 712 on their websites by which the user completes a login process. Typically, the login process will require the user to supply a username and password, and/or to provide the answer to one or more questions which were established by the account holder during an enrollment process by which the account holder came to be registered with the service providers 703 and 704. For a successful login, an authentication process 717 commences by which the user authenticates himself as owner of the token 719. Upon successful authentication, the token releases encrypted secrets which are transmitted over the network 707 to the service provider 703 or 704 whose services the user is seeking access to. The service providers 703 and 704 have servers 721 and 722 associated with them which decrypt the encrypted secrets received from the token 719. If the secrets are in order, the user is granted access to the appropriate information on the database 709 or 710 associated with the service provider 703 or 704.

As previously noted, the token is typically equipped with encryption/decryption capabilities, and is further adapted to participate in a key exchange procedure with the service provider. Various encryption/decryption algorithms are known to the art which may be used for this purpose. Similarly, various methods of key exchange may be utilized, including, for example, the use of Diffie-Hellman key exchange protocols and public key infrastructures (PKIs). Consequently, the authentication request from the service provider may be encrypted such that the authentication request can only be decrypted by the token. Similarly, the response to the authentication request may be encrypted such that it can only be decrypted by the service provider which initiated the authentication request and to which the secrets correspond.

As indicated in FIG. 7, the token may be used for other purposes than to gain access to online information. Thus, in the particular embodiment depicted, the token 719 is also configured to enable the user to access a secured area through secure door access 713, and to access a bank vault 714 where the user has valuables stored.

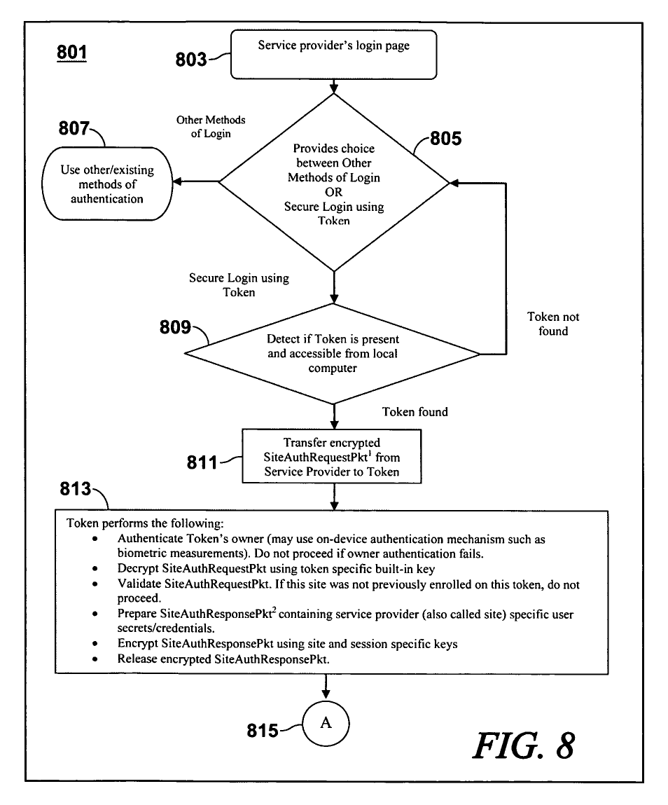

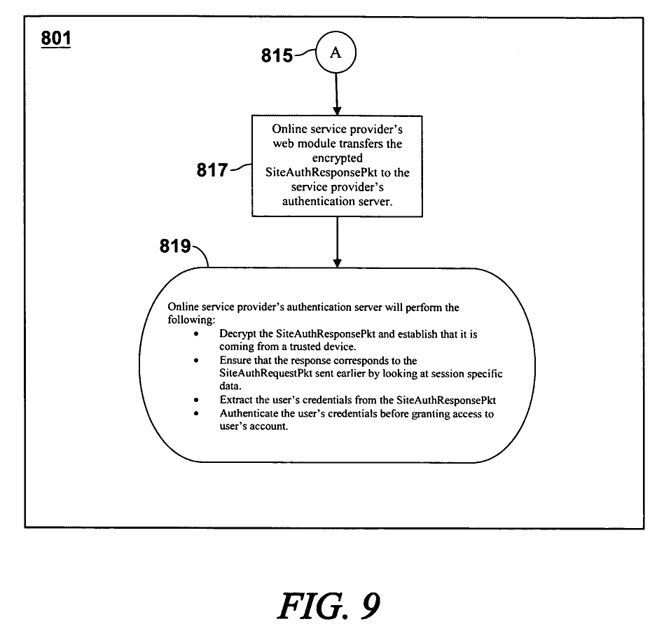

FIGS. 8-9 illustrate a particular, non-limiting embodiment of a login process that may be used in conjunction with the system depicted in FIG. 7. As seen therein, when the user wants to access online services through a service provider, the user will navigate to the service provider's login page 803. In this particular embodiment, the login page provides the user with more than one choice of login procedures 805. In particular, the user may select between a secure login process using a token, or may opt for other methods of authentication 807, such as provision of a user ID and password.

If the user elects to use a token for authentication, then software associated with the login page will attempt to detect if a token is present and accessible from the user's computer 809. This may occur, for example, through the use of Java Applet or other embedded controls present on, or associated with, the website, and/or through the use of software installed on the user's computer. If no token is detected, the user may be notified of the token detection failure, and will be returned to the web page requesting choice of login method.

If a token is detected, an encrypted Site Authentication Request Packet will be sent 811 from the service provider to the token. The Site Authentication Request Packet will preferably be a data packet which can be decrypted only by the token, and which contains information which is specific to the service provider (or which is specific to the site associated with the service provider). The token utilizes this data packet to validate the identity of the online service provider.

After the Site Authentication Request Packet is transmitted from the service provider to the token, the token undertakes a series of steps which culminate in release of a response. In particular, once the token receives the user authentication request from the service provider, it will authenticate the current user of the token as the owner of the token before proceeding any further (the service provider's website may generate a service access failure message if owner authentication fails, in which case it may terminate the process or return it to an earlier step). This ensures that, if the owner loses the token, the token will be useless to the party gaining possession of it. Various methods of authenticating the user may be utilized for this purpose, including, but not limited to, biometric measurements.

After successful user authentication, the token will decrypt the authentication request packet, preferably through the use of a token-specific built-in key, and will verify that the request is coming from a service provider that has been previously enrolled on the token. If the request is coming from a service provider that is not enrolled on the token, the service provider's website may generate a service access failure message, and may terminate the process or return it to an earlier step.

If the service provider has been previously enrolled on the token, the token will generate a response packet which includes the user's secrets specific to the service provider or to the service provider's site. This response packet is preferably encrypted with session-specific keys. This response packet, which can be decrypted only by the service provider, is then sent back to the service provider. The session-specific (and preferably random) data contained in the request from the service provider, and in the response from the token, ensures that a replay-attack is not possible.

The service provider's website is equipped with a module which transfers 817 the encrypted response packet to the service provider's authentication server. Upon receipt of the response packet, the authentication server typically performs 819 certain processes. In particular, the authentication server decrypts the response packet and establishes that it is coming from a trusted device. The authentication server also ensures that the response packet corresponds to the previously sent Site Authentication Request Packet by looking at session-specific data. Once the service provider receives and decrypts the response packet, it can extract and validate the user credentials before allowing access to the user's account.

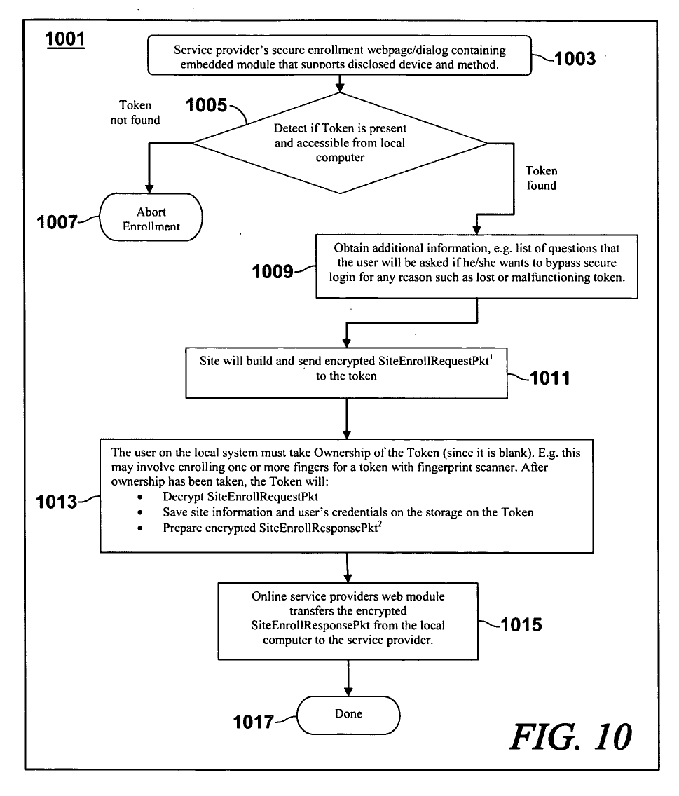

FIG. 10 illustrates a particular, non-limiting embodiment of a method by which a new service provider may be enrolled on a token in accordance with the teachings herein. As seen therein, in the particular embodiment 1001 depicted, a service provider will have a secure enrollment web page or dialog that will contain an embedded module that supports 1003 the devices and methodologies disclosed herein. This module will detect 1005 if a token is present and accessible from a local computer. If not, enrollment is aborted 1007 or proceeds no further.

If the presence of a token is detected, then additional information is obtained 1009 (this may include, for example, a list of questions that the user will be asked if the user wants to bypass secure login for any reason such as a lost or malfunctioning token). The web site hosting the secure enrollment web page then builds and sends 1011 an encrypted site enrollment request packet to the token.

The user then takes ownership 1013 of the token. Preferably, this is accomplished by providing biometric data to the token, as by submitting one or more fingers to a scan by a fingerprint scanner built into the token. After the user takes ownership of the token or establishes himself as the owner of the token, the token decrypts 1015 the site enrollment request packet. The token then saves the service provider's site information to the memory of the token, along with the owner's secrets for that service provider, and prepares an encrypted site enrollment response packet.

Next, the online service provider's web module transfers 1015 the encrypted site enrollment response packet from the local computer to the service provider. The process then terminates 1017.

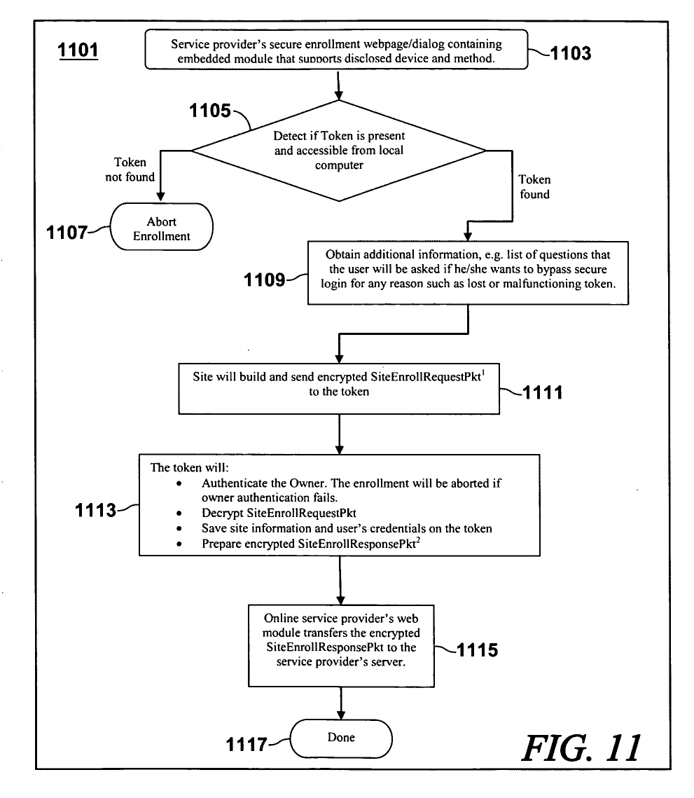

FIG. 11 illustrates a particular, non-limiting embodiment of a process (analogous to the process of FIG. 10) by which a service provider is enrolled on a token that the user has already taken ownership of. As with the previously described method, in the particular embodiment 1101 depicted, a service provider will have a secure enrollment web page or dialog that will contain an embedded module that supports 1103 the devices and methodologies disclosed herein. This module will detect 1105 if a token is present and accessible from a local computer. If not, enrollment is aborted 1107 or proceeds no further.

If the presence of a token is detected, then additional information is obtained 1109 (this may include, for example, a list of questions that the user will be asked if the user wishes to bypass secure login for any reason such as a lost or malfunctioning token). The web site hosting the secure enrollment web page then builds and sends 1111 an encrypted site enrollment request packet to the token.

The token then authenticates 1113 the current user as the owner of the token. Preferably, this is accomplished by obtaining biometric data from the user, as by scanning one or more of the user's fingers with a fingerprint scanner built into the token such that neither the captured fingerprints, nor the previously saved owner's fingerprints, ever leave the token. After the user is authenticated, the token decrypts 1113 the site enrollment request packet. The token then saves the service provider's site information to the memory of the token, along with the user's secrets for that service provider, and prepares an encrypted site enrollment response packet.

Next, the online service provider's web module transfers 1115 the encrypted site enrollment response packet from the local computer to the service provider. The process then terminates 1117.

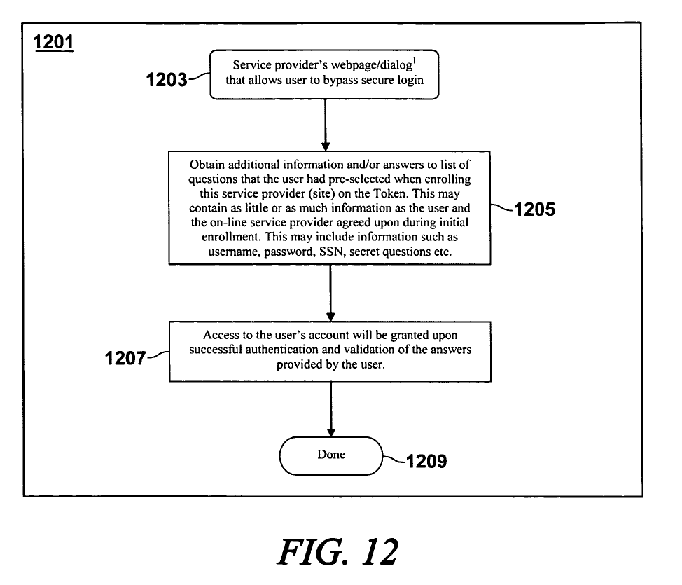

FIG. 12 illustrates a particular, non-limiting embodiment of a process by which an owner of a token may login to his account when the token is lost, malfunctioning or unavailable. In the process 1201 depicted therein, the token owner accesses 1203 the service provider's webpage or web dialog which allows the user to bypass the token-facilitated procedure for secure login.

The website then obtains additional information 1205 and/or answers to a list of questions that the user had preselected or agreed upon when enrolling the service provider on the token. This additional information may include, for example, information such as username, password, social security number, secret questions, and the like. Access to the user's account is then granted 1207 upon successful authentication and validation of the answers provided by the user. The process then terminates 1209.

It will be appreciated that various modifications of the foregoing processes and devices are possible. For example, while frequent reference has been made to the use of fingerprint scanners as the basis for biometric data in the devices and methodologies described herein, it will be appreciated that various other types of biometric scanners and data may also be utilized. These include, without limitation, the use of palm scans, iris scans, retinal scans, facial feature scans, odor scans, DNA analysis, handwriting recognition, voice recognition, facial thermographs, and the like.

Moreover, while it is preferred that the tokens described herein have one or more biometric scanners built into them, various embodiments are also possible in accordance with the teachings herein in which the token is used in conjunction with a computer or other device which itself has biometric scanning abilities. In such embodiments, the token and/or the device it is being used in conjunction with may be equipped with security features to ensure that the person using the token and the person whose biometric features are being scanned is the same. By way of specific example, some laptop computers are currently provided with fingerprint scanners as a security feature. In some embodiments of the devices and methodologies described herein, these scanners may be utilized to capture the biometric credentials of the user in place of, or in addition to, a scanner built into the token.

It will also be appreciated that various types of credentials may be utilized in the devices and methodologies described herein, and that such credentials are not limited to biometric credentials. Preferably, the credentials utilized uniquely identify the user and the owner of the device or token and, if the two are not identical, allows the device or token to distinguish between them.

It will further be appreciated that a device or token made in accordance with the teachings herein may be provided with various security features. For example, the device may be adapted to wipe its memory in the event that the device is tampered with.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A method for authenticating the owner of a device to a service provider, comprising:
capturing an initial set of credentials from the owner of the device;
storing the initial set of credentials in a memory provided in the device;
storing the owner's secrets corresponding to a plurality of service providers in the memory;
receiving an authentication request from one of said plurality of service providers;
in response to the authentication request, capturing a set of credentials from the current user of the device; and
revealing the owner's secrets which correspond to the service provider requesting the authentication if and only if the current user's credentials match the owner's credentials.

2. The method of claim 1, wherein the authentication request is encrypted by the requesting service provider with a first device specific key, wherein the device is equipped with a request processing engine, and further comprising:
decrypting the authentication request with the request processing engine.

3. The method of claim 2, further comprising: uniquely identifying the requesting service provider to the request processing engine on the device.

4. (canceled)

5. The method of claim 2, wherein the authentication request is decrypted by the request processing engine using a second device specific key.

6. (canceled)

7. The method of claim 1, wherein storing the owner's secrets corresponding to a plurality of service providers in the memory of the device includes:
receiving a request from one of the plurality of service providers to save the owner's secrets corresponding to that service provider in the memory;
obtaining a set of credentials from the current user of the device; and
saving the owner's secrets corresponding to the service provider in the memory if and only if the current user's set of credentials matches the owner's set of credentials.

8. The method of claim 7, further comprising:
sending an encrypted response to the requesting service provider indicating successful completion of the request.

9. The method of claim 1, wherein revealing from the memory the owner's secrets which corresponds to one of the plurality of service providers includes:
receiving a request from one of the plurality of service providers to retrieve secrets corresponding to that service provider from the memory on the device;
obtaining a set of credentials from the current user of the device; and
authenticating the user of the device as the owner of the device if and only if the current user's set of credentials matches the owner's set of credentials.

10. The method of claim 9, further comprising:
obtaining from the memory on the device the owner's secrets corresponding to the service provider who has initiated the request;
encrypting the secrets using a service provider specific key; and
transmitting the encrypted secrets to the service provider.

11. The method of claim 10, wherein the owner's service provider specific secrets are encrypted using a set of keys established during a key exchange algorithm conducted with the service provider.

12. The method of claim 1, wherein all requests from the service provider to the device, and all responses from the device to the service provider, contain session specific data.

13. The method of claim 12, wherein the user is authenticated by the service provider if and only if (a) the session specific data corresponds to the present session between the service provider and the user, and (b) valid secrets for that service provider are returned from the device.

14. The method of claim 1, wherein the owner's secrets corresponding to a service provider include one or more credentials selected from the group consisting of a usernames, passwords, secret questions, answers to questions, binary data identifying the user to the service provider, and certificates issued to the user by the service provider or its agent.

15-18. (canceled)

19. A method for authenticating a first party to a second party, comprising:
requiring the first party to demonstrate knowledge of a secret shared between the first and second parties;
requiring the first party to establish possession of a token; and
requiring the first party to demonstrate ownership of said token.

20. The method of claim 19, wherein ownership of the token is demonstrated by:
obtaining credentials from the first party; and
comparing the obtained credentials to credentials of the owner of the token which are stored on the token.

21. The method of claim 19, wherein authentication of the first party to the second party comprises bringing the token into communication with the second party.

22. The method of claim 21, wherein authentication of the first party to the second party comprises causing the token to release a secret which is specific to the second party.

23. The method of claim 22, wherein the secret is released in an encrypted form which can be decrypted only by the second party.

24. The method of claim 21, wherein authentication of the first party to the second party comprises sending an encrypted request from the second party which can only be decrypted by the token.

25. The method of claim 20, wherein the credentials of the first party and the owner's credentials comprise biometric data.

26. A system, comprising:
a plurality of service providers;
a user registered with said plurality of service providers; and
a device adapted to allow the user to obtain access to services from any of said service providers by releasing to that service provider a secret which is specific to that service provider and which is stored on the device;
wherein the device is further adapted to obtain a first set of credentials from the user of the device and to compare the first set of credentials with a second set of credentials which are stored on the device and which were obtained from the owner of the device.

27. (canceled)

28. A device, comprising:
a memory adapted to store the credentials of the device's owner therein, and being further adapted to store the owner's secrets from a plurality of service providers therein;
an owner authentication engine which is adapted to capture and store credentials from the owner of the device, and which is further adapted to compare those credentials with the credentials of a current user of the device; an interface adapted to allow the device to communicate with the plurality of service providers over a network; and
a request processing engine on the device, said request processing engine being adapted, upon a request from one of said service providers, to authenticate the owner, and being further adapted, upon successful authentication of the owner, to reveal the owner's secrets which correspond to that service provider.

29-40. (canceled)
